(19) United States
(12) Patent Application Publication
(10) Pub. No.: US 2019/0250766 A1
(43) Pub. Date: Aug. 15, 2019

(54) CAPACITIVE SENSING DEVICE, METHOD FOR OBTAINING TOUCH THRESHOLDS UNDER DIFFERENT CONTROL CONDITIONS OF THE SAME, AND CORRECTION METHOD FOR THE SAME

(71) Applicant: Shang-Li LEE, Keelung City (TW)

(72) Inventor: Shang-Li LEE, Keelung City (TW)

(21) Appl. No.: 16/265,052

(22) Filed: Feb. 1, 2019

(30) Foreign Application Priority Data
Feb. 14, 2018 (TW) 107105572

(51) Int. Cl. G06F 3/041; G06F 3/044

(52) U.S. Cl. CPC G06F 3/0418; G06F 3/044

(57) ABSTRACT

A capacitive sensing device, a method for obtaining touch thresholds under different control conditions of the same, and a correction method for the same are applicable to a capacitive sensing device. Herein, by simulating a touch event, reaction ranges of touch sensing signals of a signal sensor under different control conditions are found, and corresponding standard touch references are set according to the reaction ranges, so as to obtain and maintain clean references under the different conditions, and then improve accuracy of distinguishing touch sensing signals.

### CROSS-REFERENCE TO RELATED APPLICATION

This non-provisional application claims priority under 35 U.S.C. § 119(a) to Patent Application No. 107105572 in Taiwan, R.O.C. on Feb. 14, 2018, the entire contents of which are hereby incorporated by reference.

### BACKGROUND

### Technical Field

The present invention relates to a capacitive sensing technology, and in particular, to a capacitive sensing device, a method for obtaining touch thresholds under different control conditions of the same, and a correction method for the same.

### Related Art

To improve use convenience, in increasing electronic devices, a touch screen is used as an operation interface, so that a user directly clicks a picture on the touch screen to perform an operation, thereby providing a more convenient and human-based operation mode. The touch screen is mainly formed by a display providing a display function and a sensing device providing a touch function.

Generally, the sensing device knows, by using a self-capacitance sensing technology and/or a mutual capacitance sensing technology, whether a panel is touched by the user. In a sensing process, when the sensing device detects a change in a capacitance value at a coordinate location, the sensing device judges that this coordinate location is touched by the user. Therefore, during operations, the sensing device stores a non-touch capacitance value for each coordinate location, and when subsequently receiving a most recent capacitance value, judges, by comparing the most recent capacitance value with the non-touch capacitance value, whether a location corresponding to this capacitance value is touched.

However, when a noise occurs, a controller performs a frequency hopping action, and signals of a same finger that are measured in different measurement modes are also different.

As a result, a touch misjudgment may be caused.

### SUMMARY

In an embodiment, a method for obtaining touch thresholds under different control conditions of a capacitive sensing device includes: sequentially selecting a plurality of control conditions; generating signal reaction values of a signal sensor under each of the selected control conditions by simulating a touch event; recording the signal reaction values of the sensing points generated under each of the selected control conditions to serve as a plurality of standard reaction values corresponding to the selected control condition; and setting a standard touch reference according to the standard reaction values corresponding to each of the selected control conditions. Each control condition includes a group of signal parameters, and any control condition has at least a signal parameter different from those of other control conditions. The signal sensor includes a plurality of driving electrode lines and a plurality of sensing electrode lines, and the driving electrode lines and the sensing electrode lines are disposed in a staggered manner to define the sensing points. Under each selected control condition, the step of generating a signal reaction value includes: performing touch detection on the sensing points in accordance with the selected control condition to generate a plurality of background signals of the sensing points; simulating the touch event to generate a touch simulation signal; integrating the background signal of each sensing point and the touch simulation signal to obtain a touch sensing signal of each sensing point; and comparing the touch sensing signal of each sensing point with a value measured when any sensing electrode line other than an sensing electrode line defining the sensing point of the sensing electrode lines is grounded, so as to obtain the signal reaction value of each sensing point.

In an embodiment, a correction method for a capacitive sensing device includes: performing touch detection on the sensing points in accordance with a control condition to generate a plurality of background signals of the sensing points; simulating a touch event to generate a touch simulation signal; integrating the background signal of each sensing point and the touch simulation signal to obtain a touch sensing signal of each sensing point; comparing the touch sensing signal of each sensing point with a value measured when any sensing electrode line other than an sensing electrode line defining the sensing point is grounded, so as to obtain an actual reaction value of each sensing point; and setting a touch threshold of the sensing point according to the actual reaction value of each sensing point. The sensing points is defined by a plurality of driving electrode lines and a plurality of sensing electrode lines that are disposed in a staggered manner, and the control condition includes a group of signal parameters.

In an embodiment, a capacitive sensing device includes: a plurality of driving electrode lines, a plurality of sensing electrode lines, and a signal processing circuit. The driving electrode lines and the sensing electrode lines are staggered, and the driving electrode lines and the sensing electrode lines define a plurality of sensing points. The signal processing circuit is electrically connected to the driving electrode lines and the sensing electrode lines, and the signal processing circuit executes a correction process and performs touch detection on the sensing points based on a touch threshold of the sensing points. The correction process includes: driving each driving electrode line in accordance with a control condition; measuring, under driving of the driving electrode line corresponding to each sensing point, an sensing electrode line corresponding to the sensing point to obtain a background signal of the sensing point; simulating a touch event to generate a touch simulation signal; integrating the background signal of each sensing point and the touch simulation signal to obtain a touch sensing signal of each sensing point; comparing the touch sensing signal of each sensing point with a value measured when any sensing electrode line other than an sensing electrode line defining the sensing point is grounded, so as to obtain an actual reaction value of each sensing point; and setting a touch threshold of the sensing points according to the actual reaction value of each sensing point.

To sum up, the capacitive sensing device, the method for obtaining touch thresholds under different control conditions of the same, and the correction method for the same according to the present invention are applicable to a capacitive sensing device that can provide corresponding touch thresholds based on different signal parameter sets, so as to avoid a case in which a signal difference caused by different signal parameters causes a misjudgment.

### BRIEF DESCRIPTION OF THE DRAWINGS

The present invention will become more fully understood from the detailed description given herein below for illustration only, and thus are not limitative of the present invention, and wherein:

FIG. 1 is a schematic block diagram of a capacitive sensing device according to an embodiment of the present invention;

FIG. 2 is a schematic diagram of an embodiment of a signal sensor in FIG. 1;

FIG. 3 is a schematic flowchart of a correction method for a capacitive sensing device according to an embodiment of the present invention;

FIG. 4 is a schematic flowchart of a correction method for a capacitive sensing device according to another embodiment of the present invention;

FIG. 5 is a schematic flowchart of a correction method for a capacitive sensing device according to still another embodiment of the present invention;

FIG. 6 is a schematic flowchart of a method for obtaining touch thresholds under different control conditions of a capacitive sensing device according to an embodiment of the present invention;

FIG. 7 is a schematic flowchart of an exemplary example of step S03 in FIG. 6;

FIG. 8 is a schematic diagram of an exemplary example of a signal simulation unit in FIG. 1;

FIG. 9 is a schematic diagram of another exemplary example of a signal simulation unit in FIG. 1; and

FIG. 10 is a schematic diagram of still another exemplary example of a signal simulation unit in FIG. 1.

### DETAILED DESCRIPTION

First, a correction method for a capacitive sensing device according to any embodiment of the present invention or a method for obtaining touch thresholds under different control conditions of a capacitive sensing device according to any embodiment of the present invention may be applicable to a capacitive sensing device, for example but not limited to, a touch panel, an electronic drawing board, or a handwriting tablet. In some embodiments, the capacitive sensing device and a display may be further integrated into a touch screen. Moreover, touch of the capacitive sensing device may occur by using a hand, a stylus pen, a touch drawing pen, or another touch element.

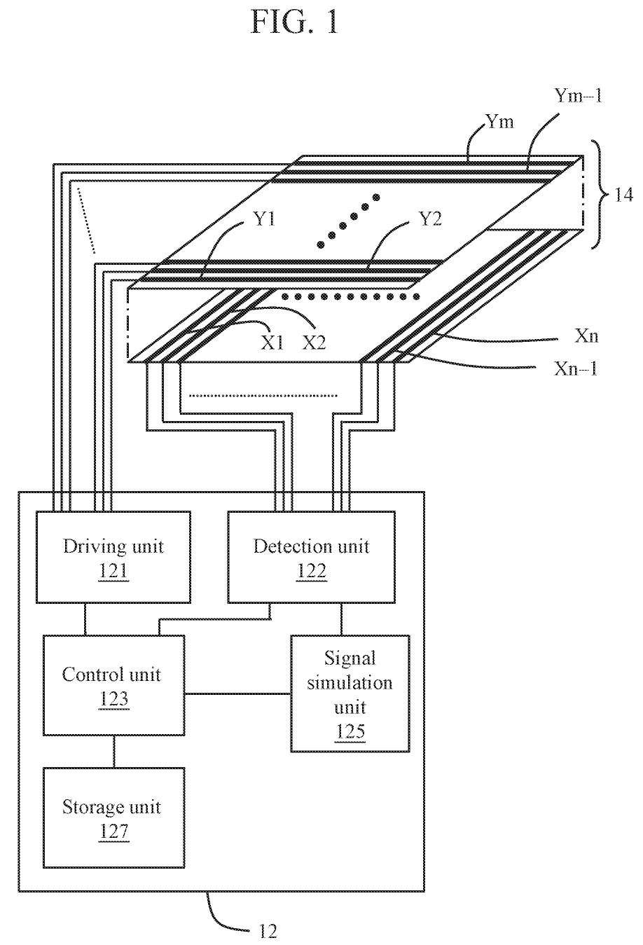

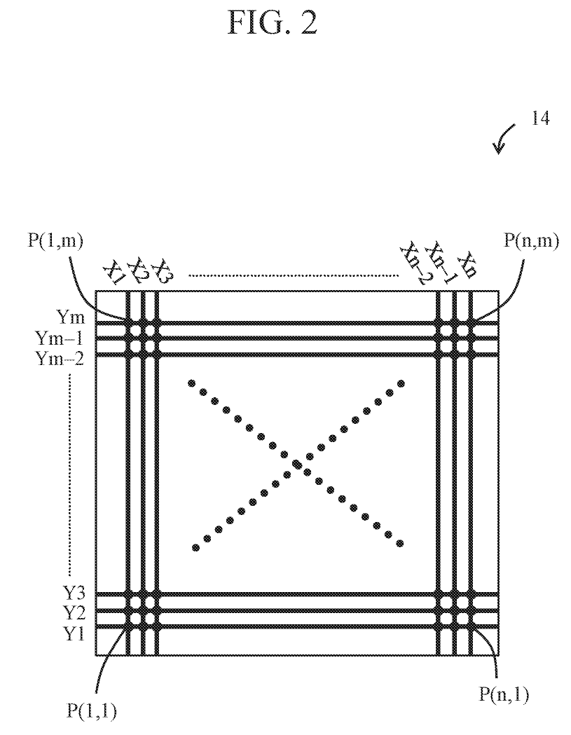

FIG. 1 is a schematic block diagram of a capacitive sensing device according to an embodiment of the present invention. Referring to FIG. 1, the capacitive sensing device includes a signal processing circuit 12 and a signal sensor 14. The signal sensor 14 is connected to the signal processing circuit 12. The signal sensor 14 includes a plurality of electrodes (for example, driving electrode lines X1 to Xn and sensing electrode lines Y1 to Ym) configured in a staggered manner. That is, the driving electrode lines X1 to Xn cross the sensing electrode lines Y1 to Ym, where n and m are positive integers, and n may be equal to m, or may be not equal to m. Viewed from the top view, the driving electrode lines X1 to Xn and the sensing electrode lines Y1 to Ym are staggered with each other, and define a plurality of sensing points P(1,1) to P(n,m) configured in a matrix, as shown in FIG. 2. In some embodiments, viewed from the top view, the driving electrode lines X1 to Xn and the sensing electrode lines Y1 to Ym that are staggered are in a rhombic honeycomb shape, a mesh shape or a grid shape. In some embodiments, the driving electrode lines X1 to Xn and the sensing electrode lines Y1 to Ym may be located on different planes (located on different sensing layers), and an insulation layer (not shown) may be sandwiched between the different planes, but the present invention is not limited thereto. In some other embodiments, the driving electrode lines X1 to Xn and the sensing electrode lines Y1 to Ym may be alternatively located on a same plane, that is, located on only a single sensing layer.

The signal processing circuit 12 includes a driving/detection unit and a control unit 123. The control unit 123 is coupled to the driving/detection unit. The driving/detection unit includes a driving unit 121 and a detection unit 122. Herein, depending on a current situation during design the driving unit 121 and the detection unit 122 may be integrated into a single element, or may be implemented by using two elements. The driving unit 121 is used to output, based on a control condition, a driving signal to the driving electrode lines X1 to Xn, and the detection unit 122 is used to measure the sensing electrode lines Y1 to Ym. Herein, the control unit 123 can be used to control operations of the driving/detection unit, judge a capacitance value change of each sensing point according to a background signal (a capacitance value at the time of determining that there is no touch) and a sensing signal (a capacitance value at the time of being about to detect whether a touch occurs), then judge, according to a touch threshold and the capacitance value change, whether the corresponding sensing point is touched, and determine, based on a judgment result, whether a corresponding location signal is returned.

Herein, the capacitive sensing device can set, by performing the correction method for a capacitive sensing device according to any embodiment of the present invention, a touch threshold used when the capacitive sensing device performs touch detection, so as to avoid a case in which a signal difference caused by different signal parameters causes a misjudgment. In other words, the signal processing circuit 12 executes a correction process and performs touch detection on each sensing point based on a touch threshold that is set in the correction process. In some embodiments, the signal processing circuit 12 may execute the correction process at an occasion point such as startup, occurrence of an abnormal situation, a driving mode change (signal parameter change), or a background signal change.

Referring to FIG. 1 again, the signal processing circuit 12 may further include a signal simulation unit 125. The signal simulation unit 125 is electrically connected to the detection unit 122 and the control unit 123. The control unit 123 can control operations of each component. Under control of the control unit 123, the capacitive sensing device can execute the correction process or execute a normal process according to a requirement.

In the normal process, the detection unit 122 disconnects from the signal simulation unit 125, and the control unit 123 directly performs signal processing on a measured value of the detection unit 122, so as to judge a capacitance value change of each sensing point. Moreover, in the correction process, the detection unit 122 connects to the signal simulation unit 125. Herein, the control unit 123 enables the signal simulation unit 125 to simulate a touch event to generate a touch simulation signal. Moreover, the touch simulation signal and the background signal obtained by the detection unit 122 from the signal sensor 14 are integrated into a touch sensing signal simulating a touch of each sensing point. In this embodiment, the touch simulation signal is equivalent to occurrence of a touch event. For example, the touch simulation signal is a signal strength simulating a finger signal. Moreover, as a use area of the capacitive sensing device differs, the touch simulation signal can provide a signal strength simulating a finger signal of a user conforming to the use area. For example, a finger of a westerner is larger than that of an easterner, and therefore a capacitance value presented by a touch simulation signal of a capacitive sensing device used in a western nation is larger. Alternatively, UK is more dry than Taiwan, and therefore a touch simulation signal of a capacitive sensing device used in UK and a touch simulation signal of a capacitive sensing device used in Taiwan can present different capacitance values according to different climates.

The correction process of the capacitive sensing device is further described below in detail.

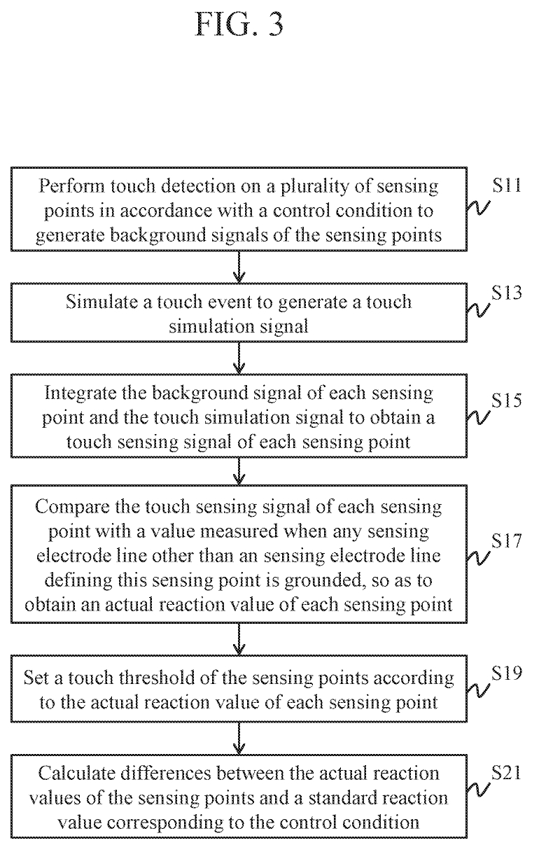

Referring to FIG. 1 to FIG. 3, FIG. 3 is a schematic flowchart of a correction method for a capacitive sensing device according to an embodiment of the present invention.

When it is determined that there is no touch occurring for the signal sensor 14, the driving/detection unit scans the signal sensor 14 in accordance with a selected control condition, so as to generate background signals at sensing points P(1,1) to P(n,m) (step S11). In an embodiment of step S11, the driving/detection unit may perform scanning once. In another embodiment of step S11, the driving/detection unit may perform scanning a plurality of times. In this case, the obtained background signal of each sensing point may be a statistic of signals obtained through the times of scanning.

The control condition includes a group of signal parameters. In some embodiments of step S11, during each time of scanning, the driving unit 121 performs touch detection on a plurality of sensing points in accordance with a group of signal parameters. Specifically, during each time of scanning, the driving unit 121 sequentially drives the driving electrode lines X1 to Xn with a driving signal having this group of signal parameters. Moreover, the detection unit 122 measures an induction capacitor of each of the sensing electrode lines Y1 to Ym for the driving electrode lines X1 to Xn that are driven, so as to obtain the background signals of the sensing points P(1,1) to P(n,m). For example, when any driving electrode line (one of X1 to Xn, Xi is used as an example) is driven, the detection unit 122 separately measures the sensing electrode lines Y1 to Ym, so as to obtain background signals of m sensing points P(i,1) to P(i,m) defined by this driving electrode line Xi and the sensing electrode lines Y1 to Ym. Then, the driving unit 121 drives a next driving electrode line X(i+1) with the driving signal having this group of signal parameters, and the detection unit 122 measures the sensing electrode lines Y1 to Ym, so as to obtain the background signals of the m sensing points P(i+1,1) to P(i+1,m), and the rest can be deduced by analogy until the background signals of all the sensing points P(1,1) to P(n,m) are obtained, where i is any one of 1 to n. In some embodiments, this group of signal parameters may be a voltage of the driving signal, a frequency of the driving signal, a waveform of the driving signal, an amplitude of the driving signal, a gain of the driving signal, or any combination thereof.

When a background signal of each sensing point (any one of P(1,1) to P(n,m)) is obtained, the signal simulation unit 125 simulates a touch event to generate a touch simulation signal (step S13), and integrates the background signal of each sensing point and the touch simulation signal to obtain a touch sensing signal of each sensing point (step S15).

Then, the control unit 123 compares the touch sensing signal of each sensing point with a value measured when any sensing electrode line other than an sensing electrode line defining this sensing point is grounded, so as to obtain a signal reaction value of each sensing point (step S17). Specifically, for each sensing point (P(i,j) is used as an example), the control unit 123 controls the detection unit 122, so that the detection unit 122 grounds any sensing electrode line Yk other than an sensing electrode line Yj corresponding to this sensing point P(i,j), measures the grounded sensing electrode line Yk, and outputs a measured value of the grounded sensing electrode line Yk to the control unit 123. The control unit 123 compares a touch sensing signal of this sensing point P(i,j) with the measured value of the sensing electrode line Yk, so as to obtain a signal reaction value of this sensing point P(i,j), where j is any one of 1 to m, and k is any one of 1 to m and is not equal to j.

However, the control unit 123 sets a touch threshold of the sensing point according to the signal reaction value of each sensing point (step S19). In some embodiments, the control unit 123 sets a touch threshold of the sensing point according to at least one statistic of the signal reaction values of the sensing points P(1,1) to P(n,m). For example, the control unit 123 may find a maximum value and a minimum value from the signal reaction values of all the sensing points P(1,1) to P(n,m), and determine, according to the maximum value and the minimum value, a receiving (allowable) range (touch threshold) of a sensing signal of a normal touch event that occurs.

In some embodiments, referring to FIG. 1, the signal processing circuit 12 may further include a storage unit 127, and the control unit 123 is coupled to the storage unit 127. The storage unit 127 stores a comparison table, and this comparison table records a plurality of different control conditions and reaction ranges corresponding to the control conditions. Each control condition has at least a signal parameter different from those of other control conditions. A reaction range corresponding to each control condition includes a standard reaction value of the sensing points P(1,1) to P(n,m) of a whole panel and a corresponding standard touch reference. In some embodiments, the reaction ranges corresponding to the control conditions recorded in the comparison table may be determined by performing actual measurement in a clean environment (such as a testing room before delivery) and be built in the storage unit 127 in advance.

In some embodiments, referring to FIG. 1, FIG. 2 and FIG. 3, after the signal reaction values of the sensing points P(1,1) to P(n,m) are obtained (step S17), the control unit 123 may read, from the storage unit 127, the standard reaction value corresponding to the currently selected control condition, and calculate differences between the signal reaction values of the sensing points P(1,1) to P(n,m) obtained in step S17 and the corresponding standard reaction value (step S21).

In some embodiments, after a reaction value difference of the currently selected control condition between a real environment and a factory environment (that is, the difference obtained in step 21) is learned, touch thresholds used under other control conditions may be adjusted by using an algorithm and based on each corresponding standard touch reference and the reaction value difference that is obtained under the currently selected control condition (that is, the difference obtained in step 21).

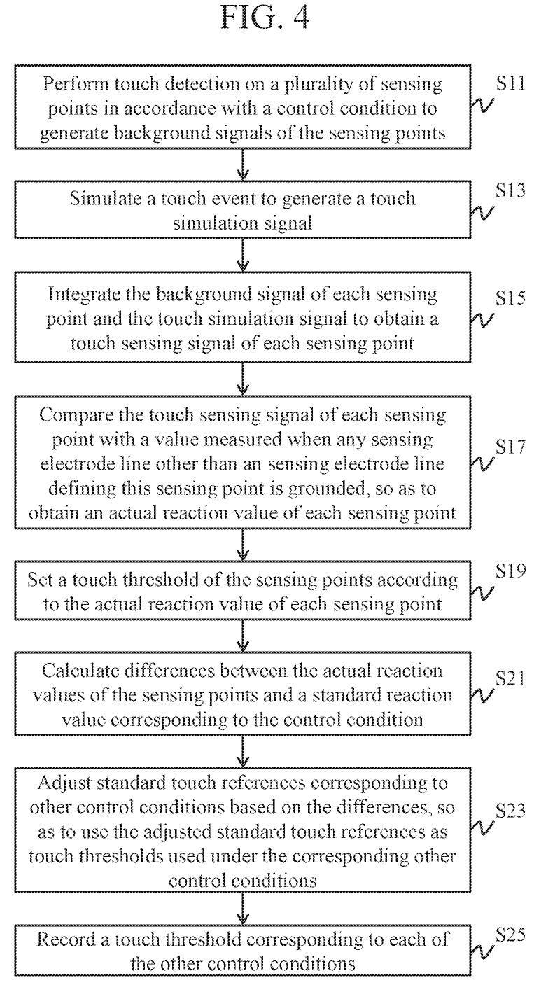

In an embodiment, referring to FIG. 1, FIG. 2 and FIG. 4, after the reaction value difference corresponding to the currently selected control condition is obtained (step S21), the control unit 123 adjusts standard touch references corresponding to other control conditions based on the obtained difference (step S23), so as to use the adjusted standard touch references as the touch thresholds used under the corresponding other control conditions. Moreover, the control unit 123 records the touch thresholds corresponding to the other control conditions in the storage unit 127 (step S25). Therefore, when the control condition is changed to one of the other control conditions subsequently, the control unit 123 may directly read the corresponding touch threshold from the storage unit 127 and set the corresponding touch threshold.

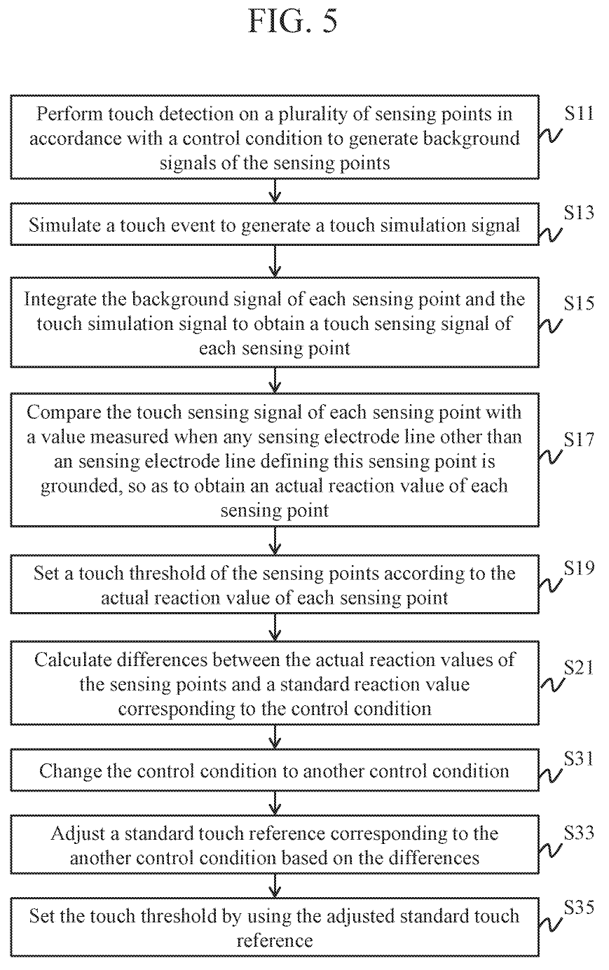

In another embodiment, referring to FIG. 1, FIG. 2 and FIG. 5, after the reaction value difference corresponding to the currently selected control condition is obtained (step S21), the control unit 123 records this difference. When the currently selected control condition is changed to another control condition (step S31), the control unit 123 reads a standard touch reference corresponding to the another control condition from the storage unit 127 and adjusts the standard touch reference corresponding to the another control condition based on the recorded difference (step S33). Then, the control unit 123 sets the touch threshold with the adjusted standard touch reference (step S35), so as to subsequently perform touch detection on each sensing point based on the set touch threshold.

After correction is completed, the signal processing circuit 12 can perform touch detection on each sensing point based on the set touch threshold.

In some embodiments, the signal processing circuit 12 may execute a building process in a clean environment without signal interference (such as a testing room before delivery), so as to store reaction ranges corresponding to a plurality of different control conditions in advance.

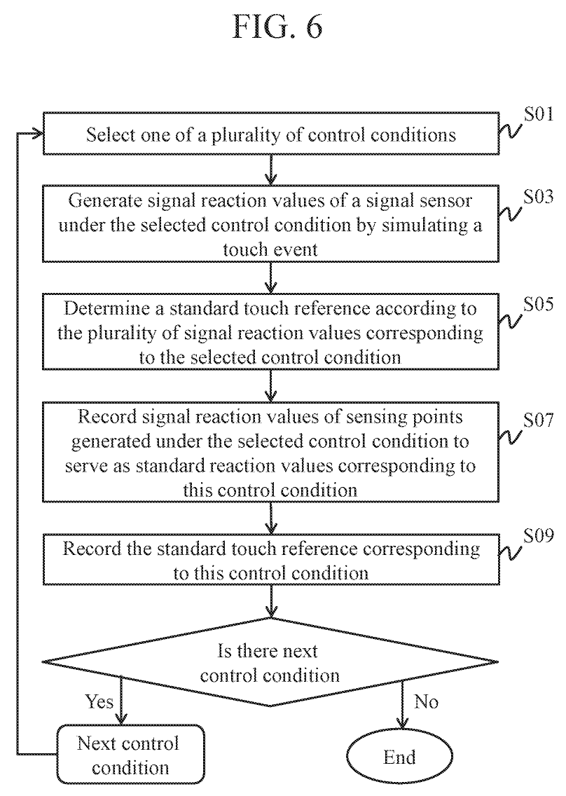

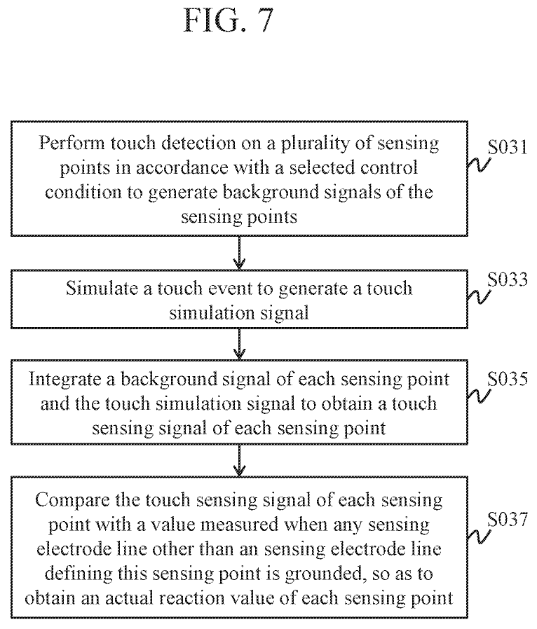

Referring to FIG. 1, FIG. 2 and FIG. 6, in the building process, the control unit 123 first selects one of a plurality of control conditions (step S01), and generates a signal reaction value of a signal sensor under a selected control condition by simulating a touch event (step S03). Each control condition includes a group of signal parameters, and any control condition has at least a signal parameter whose value is different from those of other control conditions. In some embodiments, a group of signal parameters of any control condition may be a voltage of the driving signal, a frequency of the driving signal, a waveform of the driving signal, an amplitude of the driving signal, a gain of the driving signal, or any combination thereof. In an embodiment of step S03, referring to FIG. 1, FIG. 2 and FIG. 7, when it is determined that there is no touch occurring for the signal sensor 14, the driving/detection unit scans the signal sensor 14 in accordance with a selected control condition, so as to generate background signals at sensing points P(1,1) to P(n,m) (step S031). Specifically, during each time of scanning, the driving unit 121 sequentially drives the driving electrode lines X1 to Xn with a driving signal having this group of signal parameters. Moreover, the detection unit 122 measures an induction capacitor of each of the sensing electrode lines Y1 to Ym for the driving electrode lines X1 to Xn that are driven, so as to obtain the background signals of the sensing points P(1,1) to P(n,m). In an embodiment of step S031, the driving/detection unit may perform scanning once. In another embodiment of step S031, the driving/detection unit may perform scanning a plurality of times. In this case, the obtained background signal of each sensing point may be a statistic of signals obtained through the times of scanning.

When a background signal of each sensing point (any one of P(1,1) to P(n,m)) is obtained, the signal simulation unit 125 simulates a touch event to generate a touch simulation signal (step S033), and integrates the background signal of each sensing point and the touch simulation signal to obtain a touch sensing signal of each sensing point (step S035). Then, the control unit 123 compares the touch sensing signal of each sensing point with a value measured when any sensing electrode line other than an sensing electrode line defining this sensing point is grounded, so as to obtain a signal reaction value of each sensing point (step S037).

After signal reaction values of the sensing points P(1,1) to P(n,m) corresponding to the selected control condition are obtained (step S03), the control unit 123 may determine a standard touch reference according to the signal reaction values corresponding to the selected control condition (step S05). In some embodiments, the control unit 123 determines the standard touch reference of the sensing point according to at least one statistic of the signal reaction values of the sensing points P(1,1) to P(n,m). For example, the control unit 123 may find a maximum value and a minimum value from the signal reaction values of all the sensing points P(1,1) to P(n,m), and determine, according to the maximum value and the minimum value, a receiving (allowable) range (standard touch reference) of a sensing signal of a normal touch event that occurs.

After the signal reaction value (step S03) and the standard touch reference (step S05) are obtained, the control unit 123 records the obtained signal reaction value in the storage unit 127 to serve as a standard reaction value corresponding to this control condition (step S07), and records the standard reaction value corresponding to the obtained standard touch reference in the storage unit 127 to serve as the standard touch reference corresponding to this control condition (step S09).

Then, the control unit 123 selects a next control condition (that is, returns to perform step S01) and continues to perform steps S03 to S09. In other words, the control unit 123 repeatedly performs steps S01 to S09 in accordance with different control conditions, until standard reaction values and standard touch references of the used control conditions are generated and recorded. In this way, a building process of reaction ranges of different control conditions is completed.

Based on this, in a subsequent correction process, a reaction value difference between a real environment and a factory environment may be first confirmed in accordance with a control condition, and then touch detection corresponding to other control conditions is directly adjusted by using an algorithm and based on the confirmed difference and pre-built reaction ranges without the need of confirming a reaction value difference between a real environment and a factory environment for each control condition.

It should be understood that, an execution sequence of the steps is not limited to the foregoing described sequence, and the execution sequence may be properly adjusted according to execution content of the steps.

In some embodiments, the signal simulation unit 125 can be implemented by a software or hardware circuit.

In an exemplary example, the signal simulation unit 125 may be an impedance switch circuit simulating the signal sensor 14, and may simulate, by switching on or off (crossing) a serial-connected resistor in the impedance switch circuit, occurrence of a touch or occurrence of no touch.

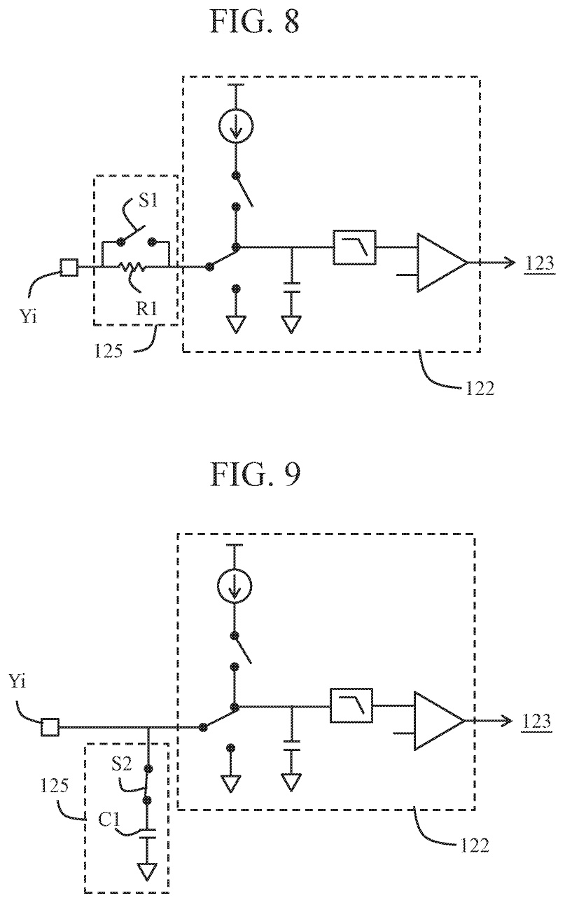

For example, a sensing point P(j,i) defined by a driving electrode line Xj and an sensing electrode line Yi is used as an example. Referring to FIG. 8, the signal simulation unit 125 may include one or more combinations circuits each having a switch S1 and a resistor R1. Herein, a capacitor switch circuit is used as an example of the detection unit 122, an input of the detection unit 122 is coupled to the sensing electrode line Yi through the resistor R1, and the switch S1 is coupled to two ends of the corresponding resistor R1. The driving electrode line Xj may be any one of first electrode lines X1 to Xn, that is, j may be any one of 1 to n. The sensing electrode line Yi may be any one of second electrode lines Y1 to Ym, that is, i may be any one of 1 to m.

In the normal process, the switch S1 is electrically connected between the two ends of the resistor R1, the detection unit 122 directly measures an induction capacitor of the sensing electrode line Yi for the driving electrode line Xj and outputs a measured value to the control unit 123. In the correction process or the building process, the switch S1 is switched off, so that the resistor R1 is in a signal connection to the input of the detection unit 122. In this case, the detection unit 122 generates a corresponding voltage drop (the touch simulation signal) through the resistor R1 for a measured value (the background signal of the sensing point P(j,i)) of the induction capacitor of the sensing electrode line Yi for the driving electrode line Xj to form a touch sensing signal, and then outputs the touch sensing signal to the control unit 123.

In some embodiments, when the signal simulation unit 125 has a plurality of combinations circuits each having a switch S1 and a resistor R1, a quantity of resistors R1 connected to the detection unit 122 depends on on/off of the switches S1 in the combination circuits, to provide touch simulation signals corresponding to different capacitance values, that is, different resistance values are signal reactions representing touches caused by different touch elements (such as, a finger, water or a foreign matter). In some embodiments, when the signal simulation unit 125 has a single combination circuit having a single switch S1 and a single resistor R1, the resistor R1 may be a variable resistor, and the control unit 123 may regulate a resistance value of the variable resistor, so that the resistor R1 provides signal reactions representing touches caused by different touch elements (such as, a finger, water or a foreign matter).

In another exemplary example, the signal simulation unit 125 may be a capacitor switch circuit simulating the signal sensor 14, and may simulate, by switching on or off a parallel-connected capacitor in the capacitor switch circuit, occurrence of a touch or occurrence of no touch.

For example, a sensing point P(j,i) defined by a driving electrode line Xj and an sensing electrode line Yi is used as an example. Referring to FIG. 9, the signal simulation unit 125 may include one or more combination circuits each having a switch S2 and a capacitor C1. Herein, a capacitor switch circuit is used as an example of the detection unit 122, an input of the detection unit 122 is coupled to the sensing electrode line Yi, and the capacitor C1 is coupled to the input of the detection unit 122 through the corresponding switch S2. In other words, when the switch S2 is switched on, the variable capacitor C1 and an induction capacitor of the sensing electrode line Yi for the driving electrode line Xj are connected in parallel.

In the normal process, the switch S2 is switched off, and the detection unit 122 directly measures a capacitance value (sensing signal) of the induction capacitor of the sensing electrode line Yi for the driving electrode line Xj, and outputs the capacitance value to the control unit 123. In the correction process or the building process, the switch S2 is switched on, so that the capacitor C1 and the induction capacitor of the sensing electrode line Yi for the driving electrode line Xj are connected in parallel. The detection unit 122 measures a total sum (touch sensing signal) of the capacitance value (the background signal) of the induction capacitor of the sensing electrode line Yi for the driving electrode line Xj and the capacitance value (the touch simulation signal) of the capacitor C1, and then outputs the total sum to the control unit 123.

In some embodiments, when the signal simulation unit 125 has a plurality of combination circuits each having a switch S2 and a capacitor C1, a quantity of connected capacitors C1 connected to the detection unit 122 in parallel depends on on/off of the switches S2 in the combination circuits, to provide touch simulation signals corresponding to different capacitance values, that is, different capacitance values represent touch sensing signals of touches caused by different touch elements (such as, a finger, water or a foreign matter). In some embodiments, when the signal simulation unit 125 has a single combination circuit having a switch S2 and a capacitor C1, the capacitor C1 may be a variable capacitor, and the control unit 123 may regulate a capacitance value of the variable capacitor, so that the capacitor C1 provides signal reactions representing touches caused by different touch elements (such as, a finger, water or a foreign matter).

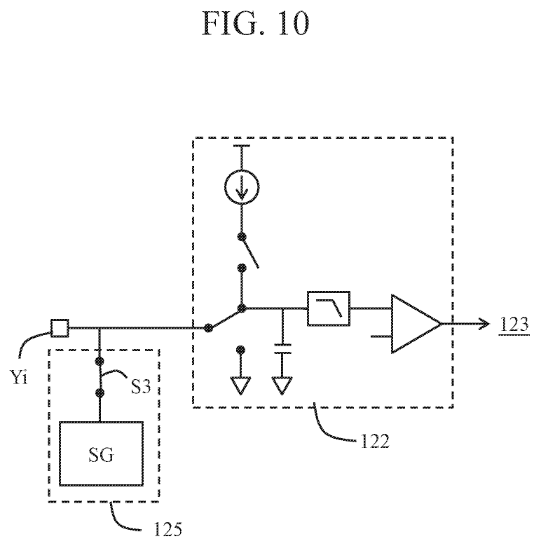

In still another exemplary example, referring to FIG. 10, the signal simulation unit 125 may be a signal generator SG, and the signal generator SG is coupled to an input of the detection unit 122 through a switch S3.

In the normal process, the switch S3 is switched off. In the correction process or the building process, the switch S3 is switched on, the signal generator SG may generate, under control of the control unit 123 and in a software form, a needed touch simulation signal, and the detection unit 122 measures a total sum (touch sensing signal) of a capacitance value (the background signal) of an induction capacitor of an sensing electrode line Yi for a driving electrode line Xj and the touch simulation signal, and then outputs the total sum to the control unit 123.

In some embodiments, the signal simulation unit 125 is built in a chip of a capacitive sensing device and is isolated from an external environment of the capacitive sensing device. In other words, for a signal sensor 14, the signal simulation unit 125 is encapsulated internally and cannot be contacted or approached (sufficiently affecting an electrical property thereof) by a finger, and therefore is not easily subjected to interference of an external noise. The chip of the built signal simulation unit 125 may be an independent chip that does not implement other elements (a control unit, a driving/detection unit and a path selection unit), or be a multi-functional chip that implements the signal simulation unit 125 and other elements (a control unit, a driving/detection unit, a path selection unit or any combination thereof). In other words, the signal processing circuit 12 may be implemented by one or more chips. In some embodiments, the storage unit 127 may be further used to store a related software/firmware program, data, data and a combination thereof. Herein, the storage unit 127 may be implemented by one or more memories.

To sum up, the capacitive sensing device, the method for obtaining touch thresholds under different control conditions of the same, and the correction method for the same according to the present invention are applicable to a capacitive sensing device that can provide corresponding touch thresholds based on different signal parameter sets, so as to avoid a case in which a signal difference caused by different signal parameters causes a misjudgment. In some embodiments, in the correction method for a capacitive sensing device and the capacitive sensing device according to the present invention, signal parameters of a driving signal such as a waveform, an amplitude, a frequency, a gain, a voltage or a combination thereof can be controlled, and rating ranges (touch thresholds) under different control conditions can be correspondingly obtained, so as to obtain and maintain clean references under the different conditions, and then improve accuracy of distinguishing touch sensing signals.

What is claimed is:

1. A method for obtaining touch thresholds under different control conditions of a capacitive sensing device, comprising:
sequentially selecting a plurality of control conditions, wherein each of the control conditions comprises a group of signal parameters, and any one of the plurality of control conditions has at least one signal parameter whose value is different from those of other of the plurality of control conditions;
generating signal reaction values of a signal sensor under each of the selected control conditions by simulating a touch event, wherein the signal sensor comprises a plurality of driving electrode lines and a plurality of sensing electrode lines, the plurality of driving electrode lines and the plurality of sensing electrode lines are disposed in a staggered manner to define a plurality of sensing points, and the step of generating the plurality of signal reaction values under each of the selected control conditions comprises:
performing touch detection on the plurality of sensing points in accordance with the selected control condition to generate a plurality of background signals of the plurality of sensing points;
simulating the touch event to generate a touch simulation signal;
integrating the background signal of each of the sensing points and the touch simulation signal to obtain a touch sensing signal of each of the sensing points; and
comparing the touch sensing signal of each of the sensing points with a value measured when any sensing electrode line other than an sensing electrode line defining the sensing point of the plurality of sensing electrode lines is grounded, so as to obtain the signal reaction value of each of the sensing points;
determining a standard touch reference according to the plurality of signal reaction values corresponding to each of the selected control conditions;
recording the plurality of signal reaction values of the plurality of sensing points generated under each of the selected control conditions to serve as a plurality of standard reaction values corresponding to the control condition; and
recording the standard touch reference corresponding to each of the control conditions.

2. The method for obtaining touch thresholds under different control conditions of a capacitive sensing device according to claim 1, wherein the step of performing touch detection on the plurality of sensing points in accordance with the selected control condition to generate a plurality of background signals of the plurality of sensing points comprises:
driving each of the driving electrode lines with a driving signal having the group of signal parameters of the selected control condition; and
measuring, under driving of the driving electrode line corresponding to each of the sensing points, the sensing electrode line corresponding to the sensing point to obtain the background signal of the sensing point.

3. The method for obtaining touch thresholds under different control conditions of a capacitive sensing device according to claim 1, wherein each of the plurality of group of signal parameters are a plurality of waveforms, amplitudes, frequencies, gains, and voltages.

4. A correction method for a capacitive sensing device, comprising:
performing touch detection on a plurality of sensing points in accordance with a control condition to generate a plurality of background signals of the plurality of sensing points, wherein the plurality of sensing points is defined by a plurality of driving electrode lines and a plurality of sensing electrode lines that are disposed in a staggered manner, and the control condition comprises a group of signal parameters;
simulating a touch event to generate a touch simulation signal;
integrating the background signal of each of the sensing points and the touch simulation signal to obtain a touch sensing signal of each of the sensing points;
comparing the touch sensing signal of each of the sensing points with a value measured when any sensing electrode line other than a sensing electrode line defining the sensing point of the plurality of sensing electrode lines is grounded, so as to obtain an actual reaction value of each of the sensing points; and
setting a touch threshold of the plurality of sensing points according to the actual reaction value of each of the sensing points.

5. The correction method for a capacitive sensing device according to claim 4, further comprising:
calculating differences between the plurality of actual reaction values of the plurality of sensing points and a standard reaction value corresponding to the control condition.

6. The correction method for a capacitive sensing device according to claim 5, further comprising:
changing the control condition to another control condition, wherein the another control condition comprises another group of signal parameters, and a value of at least one signal parameter in the another group of signal parameters is different from that of the control condition;
adjusting a standard touch reference corresponding to the another control condition based on the differences; and
setting the touch threshold with the adjusted standard touch reference.

7. The correction method for a capacitive sensing device according to claim 5, further comprising:
adjusting a standard touch reference corresponding to at least one of other control conditions based on the differences, so as to use the adjusted standard touch reference as the touch threshold used under the corresponding other control conditions, wherein each of the other control conditions comprises a group of signal parameters, and a value of at least one signal parameter of the other control conditions and a value of at least one signal parameter of the control condition are different from each other; and
recording a touch threshold corresponding to each of the other control conditions.

8. The correction method for a capacitive sensing device according to claim 4, wherein the group of signal parameters are a plurality of waveforms, amplitudes, frequencies, gains, and voltages.

9. The correction method for a capacitive sensing device according to claim 4, wherein the step of performing, by the signal sensor, the touch detection on the plurality of sensing points in accordance with the group of signal parameters comprises:
driving each of the driving electrode lines with a driving signal having the group of signal parameters; and
measuring, under driving of the driving electrode line corresponding to each of the sensing points, the sensing electrode line corresponding to the sensing point to obtain the background signal of the sensing point.

10. A capacitive sensing device, comprising:
a plurality of driving electrode lines;
a plurality of sensing electrode lines, wherein the plurality of driving electrode lines and the plurality of sensing electrode lines are staggered, and the plurality of driving electrode lines and the plurality of sensing electrode lines define a plurality of sensing points; and
a signal processing circuit, electrically connected to the plurality of driving electrode lines and the plurality of sensing electrode lines, wherein the signal processing circuit executes a correction process and performs touch detection on each of the sensing points based on a touch threshold of the plurality of sensing points, wherein the correction process comprises:
driving each of the driving electrode lines in accordance with a control condition, wherein the control condition comprises a group of signal parameters;
measuring, under driving of the driving electrode line corresponding to each of the sensing points, the sensing electrode line corresponding to the sensing point to obtain a background signal of the sensing point;
simulating a touch event to generate a touch simulation signal;
integrating the background signal of each of the sensing points and the touch simulation signal to obtain a touch sensing signal of each of the sensing points;
comparing the touch sensing signal of each of the sensing points with a value measured when any sensing electrode line other than an sensing electrode line defining the sensing point of the plurality of sensing electrode lines is grounded, so as to obtain an actual reaction value of each of the sensing points; and
setting the touch threshold of the plurality of sensing points according to the actual reaction value of each of the sensing points.

11. The capacitive sensing device according to claim 10, wherein the signal processing circuit further stores a plurality of reaction ranges, the plurality of reaction ranges corresponds to different control conditions, and each of the reaction ranges comprises a standard reaction value of the plurality of sensing points and a corresponding standard touch reference.
